(19) United States
(12) Patent Application Publication
(10) Pub. No.: US 2015/0244865 A1
(43) Pub. Date: Aug. 27, 2015

(54) Cell Phone Application for Playing Voice Messages

(71) Applicants: Anton Edelman, Natanya (IL); Doron Sharon, Kfar Saba (IL); Yoel Schendel, Hod Hasharon (IL)

(72) Inventors: Anton Edelman, Natanya (IL); Doron Sharon, Kfar Saba (IL); Yoel Schendel, Hod Hasharon (IL)

(21) Appl. No.: 14/187,276

(22) Filed: Feb. 23, 2014

(51) Int. Cl. H04M 3/533

(52) U.S. Cl. CPC H04M 3/533

(57) ABSTRACT

An Internet application for cell phones that includes an independent dialer that enables the user to initiate phone calls from the cell phone and an option to extend the time interval between the moment the user finishes dialing and initiates the call and the moment the cell phone actually executes the call. During this time interval, the application plays back voice messages to the user.

### TECHNICAL FIELD

The present invention refers to an Internet application for cell phones that includes a separate and independent dialer that enables the user to initiate phone calls from his or her cell phone and an option to extend the time interval between the moment the user finishes dialing and initiates the call and the moment the cell phone actually executes the call. During this time interval, the application plays back voice messages to the user.

### BACKGROUND ART

Various systems and methods are currently known and available for playing back voice messages using telephone devices. Some of these methods operate as following: when the user, who has previously registered as a subscriber of the said system, uses the telephone device to makes a call, existing voice messages are played back to him or her, either before, during, or after the end of the said call. Such systems are used as platforms for advertising, sales promotion and marketing of products and services and they require cooperation with the land or cellular telephone network provider. The need to cooperate with the telephone network provider poses difficulties for entities that wish to establish and provide such a service. The present invention offers a good and effective solution to this problem and to other related problems by describing a cell phone application that enables to provide said service without having to cooperate with the cellular network provider.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 presents a schematic description of the components of the proposed application, which includes a cell phone (1) equipped with an independent dialer (2) that is managed and operated through a server (3).

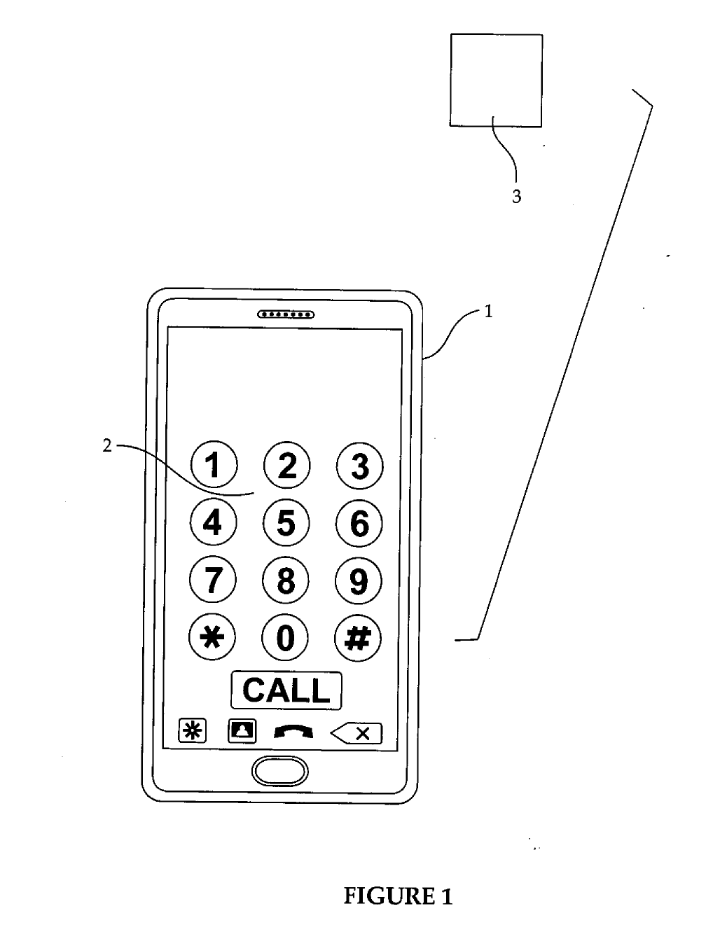

### THE INVENTION

The main objective of the present invention is to provide an Internet application for cell phones that includes an independent dialer that enables the user to initiate phone calls from the cell phone and an option to extend the time interval between the moment the user finishes dialing and initiates the call and the moment the cell phone actually executes the call. During this time interval, the application plays back voice messages to the user. The application is such that it offers the options and operations described in the present patent application without requiring the intervention of the cellular network provider.

The application, subject of the present invention, refers to an Internet application designed for cell phones devices that are equipped with an Internet connection. Any and every person can download the application to his or her cell phone. The application includes a separate and independent dialer (hereinafter referred to as the “independent dialer”) whose general design can be similar to that of standard dialers. When the user opens the application's independent dialer, he or she can use the dialer as a standard dialer to dial a number and initiate a phone call. The main feature of the application, subject of the present patent application, is the option to delay the actual execution of the call, i.e. to extend the time period from the moment the user finishes dialing the required number and initiates the call (by pressing the “Call” button) to the moment the cell phone actually executes the call (hereinafter referred to as the “delay time”). During the delay time, the application plays back voice messages to the user. Note, that the expression “voice messages” refers to any kind of expression such as tones, music, advertisements, video presentations, photos and so on.

The application can include one or more of the following options:

Registration: Any user who downloads the application to his or her cell phone may register to the application operator's database and specify certain personal information such as place of residence, gender, age, occupation, hobbies and other details that are important for market segmentation in advertising.

Log-in authorization to social networks: The user can approve and enable the application to log in to the user's social networks on his or her cell phone, or elsewhere, and retrieve information intended for market segmentation in advertising.

Log-in authorization for determining the user's location: The user can authorize and enable the application to log in to the cell phone's GPS in order to determine the user's location.

Playing voice messages to the phone call recipient: The application includes an option of playing voice messages to the phone call recipient provided he or she is a registered user of the application, although this option may possibly be used also when the phone call recipient is not a registered user.

Communication with the application while a voice message is being played:

While the user is listening to a voice message, the application may offer the user a variety of offers and/or perks. The user may then use the keyboard, according to instructions, to receive further information or perks.

Inviting the phone call recipient to download the application: The application includes the option of sending the phone call recipient a text or other message, inviting him or her to download the application.

The application is managed on a server that manages and operates the application, determines the type of voice messages each user will receive according to a variety of parameters such as user location and other characteristics that are saved in the application's database and are intended to be used for market segmentation in advertising.

What is claimed is:

1. An Internet application for cell phones that includes an independent dialer that enables the user to initiate phone calls from the cell phone, and an option to extend the time interval between the moment the user finishes dialing and initiates the call and the moment the cell phone actually executes the call wherein during this time interval the application plays back voice messages to the user.

2. The application mentioned in claim 1 wherein in addition, it includes one or more of the following options: registration via the application, which enables the user to specify personal information; log-in authorization for the application to log into the user's social networks and retrieve of information; log-in authorization for the application to log into the GPS system and determine the user's location; playing voice messages to the phone call recipient; communication with the application during voice message playback; and inviting the phone call recipient to download the application.
